(19) United States
(12) Patent Application Publication
(10) Pub. No.: US 2021/0286224 A1
(43) Pub. Date: Sep. 16, 2021

(54) DISPLAY PANEL

(71) Applicant: TCL CHINA STAR OPTOELECTRONICS TECHNOLOGY CO., LTD., Shenzhen, Guangdong (CN)

(72) Inventor: Yani CHEN, Shenzhen, Guangdong (CN)

(21) Appl. No.: 16/971,335

(22) PCT Filed: Apr. 28, 2020
(86) PCT No.: PCT/CN2020/087623

§ 371 Date: Aug. 20, 2020

(30) Foreign Application Priority Data
Mar. 12, 2020 (CN) 202010170479.9

(51) Int. Cl. G02F 1/1362; G02F 1/1368; G02F 1/1343

(52) U.S. Cl. CPC G02F 1/136286; G02F 1/1368; G02F 2201/40; G02F 1/13624; G02F 1/134345

(57) ABSTRACT

The present application provides a display panel. A main sub-pixel electrode of the display panel is divided into a first portion, a second portion, and a peripheral connection portion. A secondary sub-pixel electrode is arranged in an accommodating space formed by the first portion, the second portion, and the peripheral connection portion. A scan line is arranged at one side of the second portion away from the first portion, so that the main and secondary sub-pixel electrodes are located at the same side of the scan line. Accordingly, an opening area of the sub-pixel unit is increased, and light transmittance of a sub-pixel unit is increased.

### FIELD OF DISCLOSURE

The present invention relates to a field of display technology and in particular, to a display panel.

### DESCRIPTION OF RELATED ART

For negative liquid crystal display panels, liquid crystal molecules have much different birefringence results at different viewing angles, resulting in a color shift problem at large viewing angles.

At present, 8-domain display technology is a main method to improve the color shift problem at large viewing angles. Referring to FIG. 1, FIG. 1 is a schematic view illustrating a 3T 8-domain pixel structure of a conventional technique, that is, a pixel structure includes two sub-pixels: a main sub-pixel and a secondary sub-pixel. A pixel electrode (ITO) of each sub-pixel has a “cross” shape and is divided into four display domain regions. In the 8-domain display technology, voltages of a main sub-pixel electrode and a secondary sub-pixel electrode are different due to current leakage, which results in a difference in rotation angle of the liquid crystal molecules and improves viewing angles.

FIG. 2 is an equivalent circuit diagram of the conventional technique. With reference to FIGS. 1 and 2, a scan line 1 (Gate) turns on two thin film transistors (T1 and T2), and signals of a data line 2 (Data) enter a main sub-pixel 3 and a secondary sub-pixel 4 through a via hole 6 and a via hole 7, and a voltage of the secondary sub-pixel 4 is released to a common electrode 5 by means of a via hole 8 through a thin film transistor T3, so that the voltages of the main sub-pixel 3 and the secondary sub-pixel 4 are different. However, in this pixel structure, the via hole 6 and the via hole 7 are arranged at two sides of the scan line 1 respectively, thus occupying some of an opening area of the pixel structure, which results in a decrease in light transmittance and fails to meet an increasing demand for light transmittance.

In summary, a pixel unit of a conventional display panel is provided with via holes at two sides of the scan line, so an aperture ratio of the pixel unit is reduced, resulting in a decrease in light transmittance. Therefore, it is necessary to provide a display panel to improve this defect.

### SUMMARY

The present disclosure provides a display panel, which solves a problem that an aperture ratio of a pixel unit of a conventional display panel is reduced and light transmittance is therefore decreased because the pixel unit is provided with via holes at two sides of a scan line.

The present disclosure provides a display panel, comprising:

a first substrate, a plurality of sub-pixel units arranged in an array on the first substrate, a plurality of data lines extended along a first direction, and a plurality of scan lines extended along a direction perpendicular to the first direction;

wherein the sub-pixel unit comprises a sub-pixel electrode and a plurality of thin film transistors (TFTs), the sub-pixel electrode comprises a main sub-pixel electrode and a secondary sub-pixel electrode, the main sub-pixel electrode comprises a first portion, a second portion, and a peripheral connection portion connected to the first portion and the second portion, an accommodating space is defined among the first portion, the second portion, and the peripheral connection portion, the secondary sub-pixel electrode is disposed in the accommodating space, and the scan line connected to the sub-pixel unit is disposed at one side of the second portion away from the first portion.

According to one embodiment of the present disclosure, the main sub-pixel electrode comprises a first trunk electrode, the secondary sub-pixel electrode comprises a second trunk electrode, and the first trunk electrode and the second trunk electrode respectively divide the main sub-pixel electrode and the secondary sub-pixel electrode into a plurality of domain regions.

According to one embodiment of the present disclosure, the first trunk electrode comprises only a vertical trunk electrode extended along the first direction, and the vertical trunk electrode of the first trunk electrode divides the main sub-pixel electrode into multiple domain regions.

According to one embodiment of the present disclosure, the sub-pixel electrode further comprises a plurality of branch electrodes arranged in each domain region, the branch electrodes arranged in a same domain region are parallel and spaced apart from each other, and the branch electrodes in adjacent two domain regions have different extending directions.

According to one embodiment of the present disclosure, one of the TFTs is connected to the secondary sub-pixel electrode through a first via hole, and the first via hole is defined in the accommodating space and overlaps the second trunk electrode.

According to one embodiment of the present disclosure, the second trunk electrode comprises a vertical trunk electrode extended along the first direction and a horizontal trunk electrode extended along a direction perpendicular to the first direction, and the first via hole is defined at an intersection of the vertical trunk electrode and the horizontal trunk electrode of the second trunk electrode.

According to one embodiment of the present disclosure, the TFTs comprise a first TFT and a second TFT, the first TFT is connected to the main sub-pixel electrode, and the second TFT is connected to the secondary sub-pixel electrode.

According to one embodiment of the present disclosure, a common electrode is disposed on the first substrate, the TFTs further comprise a third TFT, a gate of the third TFT is connected to the scan line, and a source and a drain of the third TFT are connected to the second TFT and the common electrode, respectively.

According to one embodiment of the present disclosure, the common electrode and the scan line are arranged in a same layer.

According to one embodiment of the present disclosure, the peripheral connection portion comprises two strip electrodes extended along the first direction, and the two strip electrodes are respectively disposed at two sides of the main sub-pixel electrode.

The present disclosure provides a display panel, comprising:

a first substrate, a plurality of sub-pixel units disposed on the first substrate in an array, a plurality of data lines extended along a first direction, and a plurality of scan lines extended along a direction perpendicular to the first direction;

wherein the sub-pixel unit comprises a sub-pixel electrode and a plurality of thin film transistors (TFTs), the sub-pixel electrode comprises a main sub-pixel electrode, a secondary sub-pixel electrode, and a plurality of branch electrodes, the main sub-pixel electrode comprises a first portion, a second portion, and a peripheral connection portion connected to the first portion and the second portion, an accommodating space is defined among the first portion, the second portion, and the peripheral connection portion, the secondary sub-pixel electrode is disposed in the accommodating space, and the scan line connected to the sub-pixel unit is disposed at one side of the second portion away from the first portion; and

wherein the main sub-pixel electrode comprises a first trunk electrode, the secondary sub-pixel electrode comprises a second trunk electrode, and the first trunk electrode and the second trunk electrode respectively divide the main sub-pixel electrode and the secondary sub-pixel electrode into a plurality of domain regions, the branch electrodes are arranged in the domain regions, the branch electrodes arranged in the same domain region are parallel and spaced apart from each other, and the branch electrodes in adjacent two domain regions have different extending directions.

According to one embodiment of the present disclosure, the first trunk electrode comprises only a vertical trunk electrode extended along the first direction, and the vertical trunk electrode of the first trunk electrode divides the main sub-pixel electrode into multiple domain regions.

According to one embodiment of the present disclosure, one of the TFTs is connected to the secondary sub-pixel electrode through a first via hole, and the first via hole is defined in the accommodating space and overlaps the second trunk electrode.

According to one embodiment of the present disclosure, the second trunk electrode comprises a vertical trunk electrode extended along the first direction and a horizontal trunk electrode extended along a direction perpendicular to the first direction, and the first via hole is defined at an intersection of the vertical trunk electrode and the horizontal trunk electrode.

According to one embodiment of the present disclosure, the TFTs comprise a first TFT and a second TFT, the first TFT is connected to the main sub-pixel electrode, and the second TFT is connected to the secondary sub-pixel electrode.

According to one embodiment of the present disclosure, a common electrode is further disposed on the first substrate, the TFTs further comprise a third TFT, a gate of the third TFT is connected to the scan line, and a source and a drain of the third TFT are connected to the second TFT and the common electrode, respectively.

According to one embodiment of the present disclosure, the common electrode and the scan line are arranged in a same layer.

According to one embodiment of the present disclosure, the peripheral connection portion comprises two strip electrodes extended along the first direction, and the two strip electrodes are respectively disposed at both sides of the main sub-pixel electrode.

The present disclosure provides a display panel, comprising:

a first substrate, a plurality of sub-pixel units arranged in an array on the first substrate, a plurality of data lines extended along a first direction, and a plurality of scan lines extended along a direction perpendicular to the first direction;

wherein the sub-pixel unit comprises a sub-pixel electrode and a plurality of thin film transistors (TFTs), the sub-pixel electrode comprises a main sub-pixel electrode, a secondary sub-pixel electrode, and a plurality of branch electrodes, the main sub-pixel electrode comprises a first portion, a second portion, and a peripheral connection portion connected to the first portion and the second portion, an accommodating space is defined among the first portion, the second portion, and the peripheral connection portion, the secondary sub-pixel electrode is disposed in the accommodating space, and the scan line connected to the sub-pixel unit is disposed at one side of the second portion away from the first portion; and

wherein the main sub-pixel electrode comprises a first trunk electrode, the first trunk electrode comprises only a vertical trunk electrode extended along the first direction, the secondary sub-pixel electrode comprises a second trunk electrode, and the vertical trunk electrode of the first trunk electrode and the second trunk electrode of the secondary sub-pixel electrode respectively divide the main sub-pixel electrode and the secondary sub-pixel electrode into a plurality of domain regions, the branch electrodes are arranged in the domain regions, the branch electrodes arranged in the same domain region are parallel and spaced apart from each other, and the branch electrodes in adjacent two domain regions have different extending directions.

According to one embodiment of the present disclosure, one of the TFTs is connected to the secondary sub-pixel electrode through a first via hole, and the first via hole is defined in the accommodating space and overlaps the second trunk electrode.

Advantages of the present disclosure: In the display panel of the present disclosure, the main sub-pixel electrode is divided into the first portion, the second portion, and the peripheral connection portion connected to the first and second portions, and the secondary sub-pixel electrode is disposed in the accommodating space defined by the first portion, the second portion, and the peripheral connection portion. The scan line is arranged at one side of the second portion away from the first portion, so that the main sub-pixel electrode and the secondary sub-pixel electrode are located at the same side of the scan line. Therefore, it is not necessary to provide via holes connecting the main sub-pixel electrode and the secondary sub-pixel electrode at two sides of the scan line, thus increasing an opening area of the sub-pixel unit, thereby improving light transmittance of the sub-pixel unit.

### BRIEF DESCRIPTION OF DRAWINGS

In order to more clearly illustrate the embodiments of the present disclosure or related art, figures which will be described in the embodiments are briefly introduced hereinafter. It is obvious that the drawings are merely for the purposes of illustrating some embodiments of the present disclosure, and a person having ordinary skill in this field can obtain other figures according to these figures without inventive work.

FIG. 1 is a schematic structural view illustrating a pixel structure of a conventional technique;

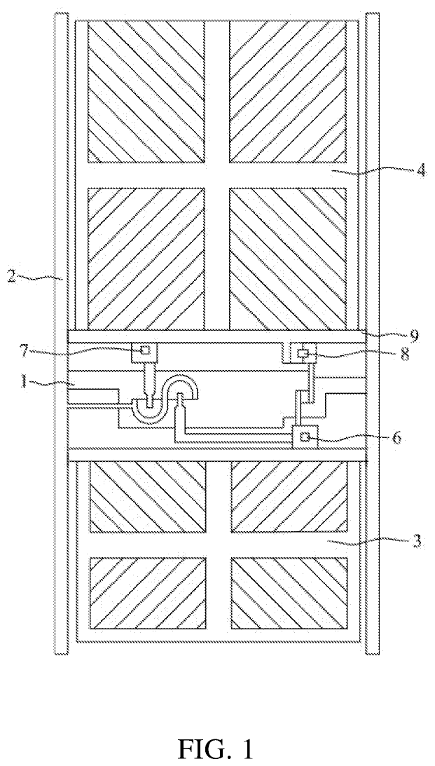

FIG. 2 is an equivalent circuit diagram of the conventional technique; and

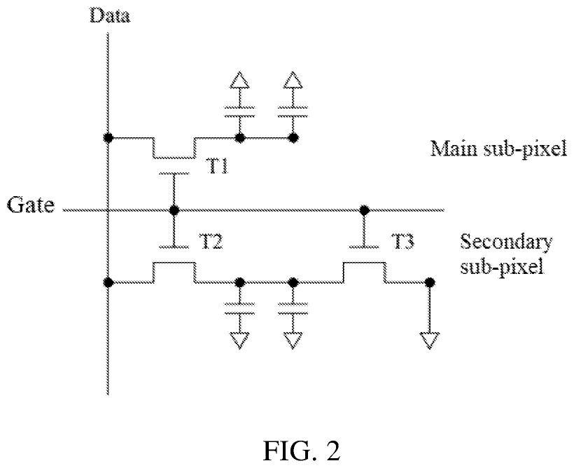

FIG. 3 is a schematic structural view illustrating a pixel unit according to one embodiment of the present disclosure.

### DETAILED DESCRIPTION OF EMBODIMENTS

Specific embodiments of the present disclosure are described below with reference to accompanying drawings. Directional terms mentioned in this disclosure, such as “upper”, “lower”, “front”, “back”, “left”, “right”, “inner”, “outer”, and “lateral”, are only for illustrative purposes based on the accompanying drawings. Therefore, the directional terms are used to illustrate and understand the present disclosure, not to limit it. In the drawings, structurally similar elements are denoted by the same reference numerals.

The present disclosure is further described below in conjunction with the accompanying drawings and specific embodiments:

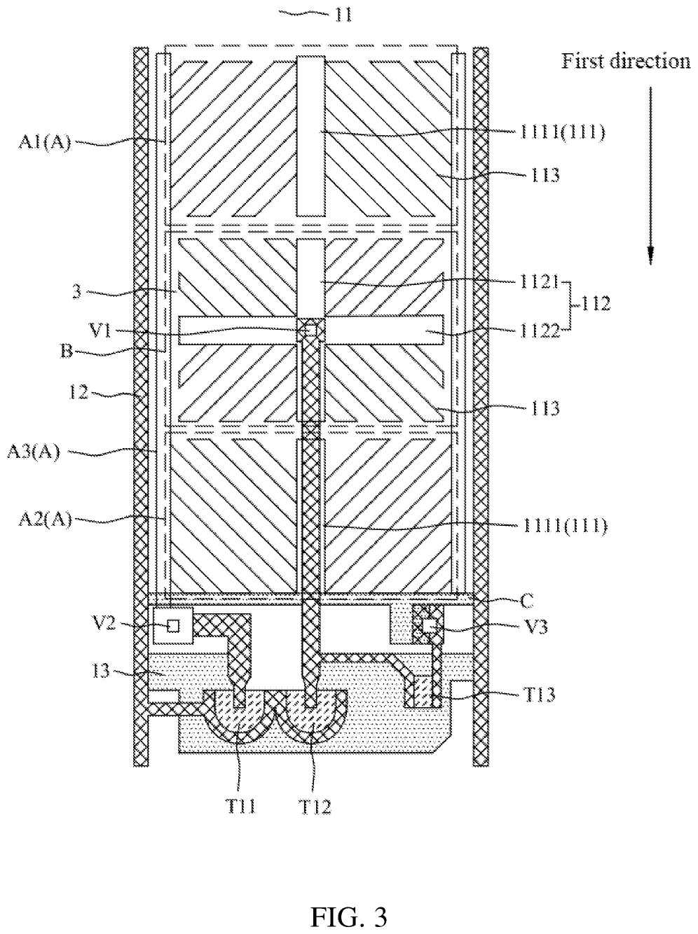

The present embodiment provides a display panel, which will be described in detail below with reference to FIG. 3. As shown in FIG. 3, FIG. 3 is a schematic structural view of a pixel unit according to one embodiment of the present disclosure. The display panel includes a first substrate. The first substrate is provided with a plurality of sub-pixel units 11 arranged in an array and a plurality of data lines 12 extending in a first direction and a plurality of scan lines 13 extending in a direction perpendicular to the first direction, wherein each data line 12 is connected to a corresponding column of the sub-pixel units 11, and each scan line 13 is connected to a corresponding row of the sub-pixel units 11.

The sub-pixel unit 11 comprises a sub-pixel electrode and a thin film transistor (TFT) disposed at one side of the sub-pixel electrode. The sub-pixel electrode comprises a main sub-pixel electrode A and a secondary sub-pixel electrode B, and the main sub-pixel electrode A comprises a first portion A1, a second portion A2 disposed opposite to each other, and a peripheral connection portion A3 connected to the first portion A1 and the second portion A2.

As shown in FIG. 3, the main sub-pixel electrode A comprises a first trunk electrode 111, and the first trunk electrode 111 is disposed in both the first portion A1 and the second portion A2. The first trunk electrode 111 divides the first portion A1 and the second portion A2 into multiple domain regions, and branch electrodes 113 are provided in each domain region.

Specifically, the first main trunk electrode 111 comprises only a first vertical trunk electrode 1111 extending in the first direction. The first vertical trunk electrode 1111 divides the first portion A1 into two domain regions and also divides the second portion into two domain regions to form four domain regions, and all the four domain regions are provided with the branch electrodes 113.

The peripheral connection portion A3 comprises two strip electrodes extended along the first direction. The two strip electrodes are respectively disposed at two sides of the first portion A1 and the second portion A2 and are each arranged between the main sub-pixel electrode A and the adjacent data line 12. Two ends of the branch electrode 113 can be connected to the first vertical trunk electrode 1111 and the peripheral connection portion A3; certainly, the two ends of the branch electrode 113 can also be connected to only one of the first vertical trunk electrode 1111 and the peripheral connection portion A3, and the present disclosure is not limited in this regard.

As shown in FIG. 3, an accommodating space is defined among the first portion A1, the second portion A2, and the peripheral connection portion A3, and the secondary sub-pixel electrode B is disposed in the accommodating space. The secondary sub-pixel electrode B comprises a second trunk electrode 112, which likewise divides the sub-subpixel electrode B into multiple domain regions.

Specifically, the second trunk electrode 112 comprises a second vertical trunk electrode 1121 extending in the first direction and a horizontal trunk electrode 1122 extending in the direction perpendicular to the first direction, and the second vertical trunk electrode 1121 and the horizontal trunk electrode cross each other and are perpendicular to each other. The secondary sub-pixel electrode B is divided into four domain regions which are also provided with branch electrodes 113 therein, thereby forming a “cross-shaped” sub-pixel electrode structure. The four domain regions of the secondary sub-pixel electrode B and the four domain regions of the main sub-pixel electrode A together constitute the 8-domain structure of the sub-pixel unit 11. During display operations of the display panel, under a certain grayscale voltage, rotation angles of liquid crystals in the domain regions of the secondary sub-pixel electrode B are small, and rotation angles of liquid crystals in the domain regions of the main sub-pixel electrode A are large, thereby forming a multi-viewing angle surrounding structure to reduce differences in birefringence results of liquid crystal molecules at different viewing angles, and minimizing a color shift problem at large viewing angles.

Furthermore, the branch electrodes 113 located in the same domain region are parallel and spaced apart from each other, and the branch electrodes 113 in adjacent two domain regions have different extending directions.

Preferably, the branch electrodes 113 extend at angles of 45°, 135°, −135°, and −45°, with respect to the first direction, in the respective domain regions.

The sub-pixel structure of the display panel according to the present disclosure is an 8-domain 3-T structure. The sub-pixel unit 111 comprises a first thin film transistor (TFT) T1, a second TFT T2, and a third TFT T3, wherein the first TFT T1 is connected to the main sub-pixel electrode A, the second TFT T2 is connected to the secondary sub-pixel electrode B, and the third TFT T3 is connected to a common electrode C.

Specifically, a gate of the first TFT T1 is connected to the scan line 13, a source of the first TFT T1 is connected to the data line 12, and a drain of the first TFT T1 is connected to the main sub-pixel electrode A through a second via hole V2 arranged between the scan line 13 and the sub-pixel electrode. A gate of the second TFT T2 is connected to the scan line 13, and a source of the second TFT T2 is connected to the data line 12. Since the sub-pixel electrode B is disposed between the first portion A1 and the second portion A2, a drain of the second TFT T2 can only be connected to the secondary sub-pixel electrode B through a trace in a second metal layer extending to a first via hole V1 arranged in the accommodating space. A gate of the third TFT T3 is connected to the scan line, a source of the third TFT T3 is connected to the drain of the second TFT T2, and a drain of the third TFT T3 is connected to the common electrode C through a via hole V3.

Furthermore, the first via hole V1 overlaps the second trunk electrode 112, and the trace connecting the second TFT T2 to the secondary sub-pixel electrode B coincides with the first vertical trunk electrode 1111 and the second vertical trunk electrode 1121. This way, the first via hole V1 and the traces are covered by a non-display portion caused by poor alignment in a position of the second trunk electrode 112. Therefore, there is no need to provide a separate opening for the first via hole V1, so that an opening area of the pixel unit 11 increases, and light transmittance improves.

Preferably, the first via hole V1 should be arranged at an intersection of the second vertical trunk electrode 1121 and the horizontal trunk electrode 1122. This way, the first via hole V1 and the trace can be best covered, so as to increase the opening area of the sub-pixel unit 11 and improve the light transmittance.

As shown in FIG. 3, the scan line 13 connected to the sub-pixel unit 11 is disposed at one side of the second portion A2 away from the first portion A1, so that both the first via hole V1 and the second via hole V2 are located at one side of the scan line 13 adjacent to the sub-pixel electrode, thereby reducing an area occupied by the above-mentioned via holes to increase the opening area of the sub-pixel unit. In addition, conductive channels formed between the sources and the drains of the first TFT T1 and the second TFT T2 are both U-shaped, and openings of the U shape are both towards the second portion A2, so that the first TFT T1 and the second TFT T2 are oriented toward the same direction, which reduces the difficulty of a manufacturing process and facilitates controlling and managing the manufacturing process.

Advantages of the present disclosure: In the display panel of the present disclosure, the main sub-pixel electrode is divided into the first portion, the second portion, and the peripheral connection portion connected to the first portion and the second portion, and the secondary sub-pixel electrode is disposed in the accommodating space defined by the first portion, the second portion, and the peripheral connection portion. The scan line is arranged at one side of the second portion away from the first portion, so that the main sub-pixel electrode and the secondary sub-pixel electrode are located at the same side of the scan line. Therefore, it is not necessary to provide via holes connecting the main sub-pixel electrode and the secondary sub-pixel electrode at two sides of the scan line, thus increasing the opening area of the sub-pixel unit, thereby improving the light transmittance of the sub-pixel unit.

In summary, although the present disclosure is disclosed as above with preferable embodiments, the above preferable embodiments are not intended to limit the present disclosure. Those of ordinary skill in the art can make various modifications and changes based on the spirit and scope of the present disclosure. Therefore, such modifications and changes are deemed to be within the protection scope of the present disclosure defined by the appended claims.

What is claimed is:

1. A display panel, comprising:
a first substrate, a plurality of sub-pixel units arranged in an array on the first substrate, a plurality of data lines extended along a first direction, and a plurality of scan lines extended along a direction perpendicular to the first direction;
wherein the sub-pixel unit comprises a sub-pixel electrode and a plurality of thin film transistors (TFTs), the sub-pixel electrode comprises a main sub-pixel electrode and a secondary sub-pixel electrode, the main sub-pixel electrode comprises a first portion, a second portion, and a peripheral connection portion connected to the first portion and the second portion, an accommodating space is defined among the first portion, the second portion, and the peripheral connection portion, the secondary sub-pixel electrode is disposed in the accommodating space, and the scan line connected to the sub-pixel unit is disposed at one side of the second portion away from the first portion.

2. The display panel according to claim 1, wherein the main sub-pixel electrode comprises a first trunk electrode, the secondary sub-pixel electrode comprises a second trunk electrode, and the first trunk electrode and the second trunk electrode respectively divide the main sub-pixel electrode and the secondary sub-pixel electrode into a plurality of domain regions.

3. The display panel according to claim 2, wherein the first trunk electrode comprises only a vertical trunk electrode extended along the first direction, and the vertical trunk electrode of the first trunk electrode divides the main sub-pixel electrode into multiple domain regions.

4. The display panel according to claim 2, wherein the sub-pixel electrode further comprises a plurality of branch electrodes arranged in each domain region, the branch electrodes arranged in a same domain region are parallel and spaced apart from each other, and the branch electrodes in adjacent two domain regions have different extending directions.

5. The display panel according to claim 2, wherein one of the TFTs is connected to the secondary sub-pixel electrode through a first via hole, and the first via hole is defined in the accommodating space and overlaps the second trunk electrode.

6. The display panel according to claim 5, wherein the second trunk electrode comprises a vertical trunk electrode extended along the first direction and a horizontal trunk electrode extended along a direction perpendicular to the first direction, and the first via hole is defined at an intersection of the vertical trunk electrode and the horizontal trunk electrode of the second trunk electrode.

7. The display panel according to claim 6, wherein the TFTs comprise a first TFT and a second TFT, the first TFT is connected to the main sub-pixel electrode, and the second TFT is connected to the secondary sub-pixel electrode.

8. The display panel according to claim 7, wherein a common electrode is disposed on the first substrate, the TFTs further comprise a third TFT, a gate of the third TFT is connected to the scan line, and a source and a drain of the third TFT are connected to the second TFT and the common electrode, respectively.

9. The display panel according to claim 8, wherein the common electrode and the scan line are arranged in a same layer.

10. The display panel according to claim 9, wherein the peripheral connection portion comprises two strip electrodes extended along the first direction, and the two strip electrodes are respectively disposed at two sides of the main sub-pixel electrode.

11. A display panel, comprising:
a first substrate, a plurality of sub-pixel units disposed on the first substrate in an array, a plurality of data lines extended along a first direction, and a plurality of scan lines extended along a direction perpendicular to the first direction;
wherein the sub-pixel unit comprises a sub-pixel electrode and a plurality of thin film transistors (TFTs), the sub-pixel electrode comprises a main sub-pixel electrode, a secondary sub-pixel electrode, and a plurality of branch electrodes, the main sub-pixel electrode comprises a first portion, a second portion, and a peripheral connection portion connected to the first portion and the second portion, an accommodating space is defined among the first portion, the second portion, and the peripheral connection portion, the secondary sub-pixel electrode is disposed in the accommodating space, and the scan line connected to the sub-pixel unit is disposed at one side of the second portion away from the first portion; and
wherein the main sub-pixel electrode comprises a first trunk electrode, the secondary sub-pixel electrode comprises a second trunk electrode, and the first trunk electrode and the second trunk electrode respectively divide the main sub-pixel electrode and the secondary sub-pixel electrode into a plurality of domain regions, the branch electrodes are arranged in the domain regions, the branch electrodes arranged in the same domain region are parallel and spaced apart from each other, and the branch electrodes in adjacent two domain regions have different extending directions.

12. The display panel according to claim 11, wherein the first trunk electrode comprises only a vertical trunk electrode extended along the first direction, and the vertical trunk electrode of the first trunk electrode divides the main sub-pixel electrode into multiple domain regions.

13. The display panel according to claim 11, wherein one of the TFTs is connected to the secondary sub-pixel electrode through a first via hole, and the first via hole is defined in the accommodating space and overlaps the second trunk electrode.

14. The display panel according to claim 13, wherein the second trunk electrode comprises a vertical trunk electrode extended along the first direction and a horizontal trunk electrode extended along a direction perpendicular to the first direction, and the first via hole is defined at an intersection of the vertical trunk electrode and the horizontal trunk electrode.

15. The display panel according to claim 14, wherein the TFTs comprise a first TFT and a second TFT, the first TFT is connected to the main sub-pixel electrode, and the second TFT is connected to the secondary sub-pixel electrode.

16. The display panel according to claim 15, wherein a common electrode is further disposed on the first substrate, the TFTs further comprise a third TFT, a gate of the third TFT is connected to the scan line, and a source and a drain of the third TFT are connected to the second TFT and the common electrode, respectively.

17. The display panel according to claim 16, wherein the common electrode and the scan line are arranged in a same layer.

18. The display panel according to claim 17, wherein the peripheral connection portion comprises two strip electrodes extended along the first direction, and the two strip electrodes are respectively disposed at both sides of the main sub-pixel electrode.

19. A display panel, comprising:
a first substrate, a plurality of sub-pixel units arranged in an array on the first substrate, a plurality of data lines extended along a first direction, and a plurality of scan lines extended along a direction perpendicular to the first direction;
wherein the sub-pixel unit comprises a sub-pixel electrode and a plurality of thin film transistors (TFTs), the sub-pixel electrode comprises a main sub-pixel electrode, a secondary sub-pixel electrode, and a plurality of branch electrodes, the main sub-pixel electrode comprises a first portion, a second portion, and a peripheral connection portion connected to the first portion and the second portion, an accommodating space is defined among the first portion, the second portion, and the peripheral connection portion, the secondary sub-pixel electrode is disposed in the accommodating space, and the scan line connected to the sub-pixel unit is disposed at one side of the second portion away from the first portion; and
wherein the main sub-pixel electrode comprises a first trunk electrode, the first trunk electrode comprises only a vertical trunk electrode extended along the first direction, the secondary sub-pixel electrode comprises a second trunk electrode, and the vertical trunk electrode of the first trunk electrode and the second trunk electrode of the secondary sub-pixel electrode respectively divide the main sub-pixel electrode and the secondary sub-pixel electrode into a plurality of domain regions, the branch electrodes are arranged in the domain regions, the branch electrodes arranged in the same domain region are parallel and spaced apart from each other, and the branch electrodes in adjacent two domain regions have different extending directions.

20. The display panel according to claim 19, wherein one of the TFTs is connected to the secondary sub-pixel electrode through a first via hole, and the first via hole is defined in the accommodating space and overlaps the second trunk electrode.
